(19) United States
(12) Patent Application Publication
(10) Pub. No.: US 2019/0062857 A1
(43) Pub. Date: Feb. 28, 2019

(54) PROCESS FOR FORMING A STAINLESS STEEL WELDMENT RESISTANT TO STRESS CORROSION CRACKING

(71) Applicant: Holtec International, Camden, NJ (US)

(72) Inventors: Krishna P. Singh, Hobe Sound, FL (US); Charles Bullard, Merion Station, PA (US)

(21) Appl. No.: 16/116,994

(22) Filed: Aug. 30, 2018

Related U.S. Application Data
(60) Provisional application No. 62/551,914, filed on Aug. 30, 2017.

(51) Int. Cl. C21D 7/04; G21F 5/12

(52) U.S. Cl. CPC C21D 7/04; G21F 5/008; G21F 5/12

(57) ABSTRACT

A process or method for forming a stainless steel weldment comprises steps including rolling a plate to form a cylindrical shell with an open butt joint or seam, welding the butt seam to close the seam, hard rolling the weld seam region including the adjacent heat affected zones in the base material, and peening the weld seam region. The weld seam region is peened in multiple successive and wider passes to progressively produce wider peening strips or regions along the weld lines. The weld may be a full penetration double-V type groove weld with double weld bevels. The welding process may include first forming the exterior weld bevel following by forming the interior weld bevel. The foregoing fabrication process converts residual tensile stress fields on the exterior of the shell weldment to compressive stress fields less susceptible to the adverse effects of stress corrosion cracking.

### CROSS-REFERENCE TO RELATED APPLICATIONS

This application claims priority to U.S. Patent Application No. 62/551,914 filed Aug. 30, 2017, which is incorporated herein by reference in its entirety.

### BACKGROUND

The present invention relates generally to processes for forming a weldment structure, and more particularly to a process for forming a cylindrical shell-type weldment structure such as for example without limitation those used to store spent nuclear fuel.

Manufacturing a welded cylindrical shell-type structure or weldment requires rolling or forming of metal plate stock followed by welding to close the seams or joints. The multi-purpose canister (MPC) is an example of a cylindrical shell-type structure or weldment used in the nuclear power generation industry. Such canisters, used to store spent nuclear fuel (SNF) and other forms of nuclear high-level waste (HLW), are typically made of austenitic stainless steel. Stainless is an excellent material for this application for a variety of reasons such as high ductility and excellent fracture resistance in the entire range of temperatures for which the canisters are designed (−40 deg. C to 400 deg. C).

Austenitic stainless, however, has one drawback: while otherwise extremely resistant to general corrosion effects, it is somewhat vulnerable to stress corrosion cracking (SCC) under certain set of environmental conditions. The conditions necessary to induce SCC in the stainless-steel canister exposed to the ambient environment are: (1) A state of tensile surface stress on the surface exposed to the environment; (2) Presence of halides in the ambient environment; and (3) A state of high relative humidity in the ambient air.

Canisters stored inside an outer ventilated module or overpack (such as Holtec's HI-STORM vertical ventilated modules (USNRC Docket #7201032) or TN's NUHOMS horizontally ventilated modules (USNRC Docket #72-1004)) in a salt water environment may fulfill all of the above conditions most of the time, thereby making them vulnerable to the onset of SCC. The region of the canister most susceptible to SCC is where the state of surface stress in the shell-type structure is invariably tensile. Such tensile regions are the weld seams and possibly the adjacent heat affected zones in the shell base material adjoining the welds where residual tensile stress is caused by the shrinkage of the weld puddle and thermal transient effects.

Such rolled cylindrical shell-type structures are further characterized by residual stresses from rolling as well as welding operations, further exacerbating the SCC problem. Rolling produces a radially symmetric stress field which is compressive on the outside surface and tensile on the inside. This is a favorable situation for the shell to prevent to SCC because the surface exposed to the ambient environment with the compressive stress field is the outer surface. FIG. 2 shows the typical residual stress distribution in the circumferential direction in the shell subsequent to rolling the originally flat plate into a cylinder.

Unlike the residual stress field from plate rolling, the residual tensile stress produced by welding of the seams or joints is locally concentrated reaching its peak in the center of the weld line and attenuating gradually away from it. The weld along the weld line is usually in a tensile state on the outer surface of the weld exposed to the ambient environment, which unfortunately makes it the prime location for SSC attack.

An improved method or process to form and protect shell-type weldments from SCC, such as particularly those used to create the multi-purpose canister (MPC) for storing spent nuclear fuel discussed above, is needed.

### BRIEF SUMMARY

Embodiments according to the present disclosure provide a method or process for forming a cylindrical shell-type weldment structure in a manner which inhibits the onset of stress corrosion cracking (SCC). In one implementation, the method may comprise steps including forming the shell such as via mechanical rolling, welding open butt joints or seams of the rolled shell, a second hard (cold) rolling of at least the surfaces of the weld seam or joint regions (i.e. weld and adjacent heat affect zones—HAZ) under relatively high compressive forces produced by the roller, and peening the seam or joint regions in multiple passes with each pass creating successively and progressively wider peening strips or regions along the weld lines. The rolling operations may be performed by a commercial mechanical roller machine. In the implementation of the method, the second hard rolling may involve re-rolling the entire shell including the welds and HAZ.

In one embodiment, the structure comprises a cylindrical shell formed from multiple rolled and welded stainless steel (e.g. austenitic stainless) shell segments which are welded together along a circumferential butt seam to create a welded assembly (i.e. weldment). The multiple shell segments may be necessary depending on the length of the structure or vessel being created (shorter structures requiring only a single shell segment in some instances). Each shell segment comprises a respective welded longitudinal seam as further described herein.

In one aspect, a method for fabricating a shell weldment includes: providing a cylindrical shell of stainless steel having an open butt seam; welding the butt seam to close the butt seam with a weld, the welding creating a heat affected zone in the shell adjoining the weld; rolling a weld zone collectively comprising the weld and heat affected zone under a compressive force after welding; and peening the weld zone. In one embodiment, the shell and weld zone is peened in multiple passes, each of the peening passes being selected to successively and progressively produce wider peened strips or regions on the shell along the weld zone and adjacent portions of the shell.

In another aspect, a method for fabricating a stainless steel shell weldment includes: rolling a flat workpiece of stainless steel to form a cylindrical shell, opposing side edges of the shell meeting at an open longitudinal butt joint; forming a double-V weld in the longitudinal butt joint to close the joint; rolling the weld and a heat affected zone in the shell adjoining the weld by applying a compressive force with a mechanical roller, the weld and heat affected zone collectively defining a weld zone; and peening the weld zone at an exterior surface of the shell.

In another aspect, a method for fabricating a stainless steel cylindrical shell weldment includes: providing a first cylindrical shell segment and a second cylindrical shell segment, each shell segment being formed of austenitic stainless steel and comprising having an open longitudinal butt seam; closing the butt seams of each of the first and second shell segments by forming a double-V longitudinal weld in the longitudinal butt seams, the formation of the longitudinal welds creating a respective heat affected zone in the shell segments adjoining each longitudinal weld; placing the first and second shell segments in abutting end-to-end relationship forming a circumferential butt seam therebetween; closing the circumferential butt seam by forming a double-V circumferential weld in the circumferential butt seam, the formation of the circumferential weld creating a respective heat affected zone in the shell segment adjoining the circumferential weld; applying an inward directed compressive force against the longitudinal and circumferential welds and their heat affected zones by a mechanical roller; and peening the shell segments along the longitudinal and circumferential welds and their respective heat affected zones in multiple peening passes, each of the peening passes being selected to successively and progressively produce wider peened strips on the shell in vicinity of the welds and their respective heat affected zones; wherein a residual stress field proximate to the longitudinal and circumferential welds on an exterior of the shell segments is compressive after the peening step.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein like elements are labeled similarly and in which:

FIG. 1 is a perspective view of a rolled and welded cylindrical shell-type assembly or weldment in the form of a canister used for storing spent nuclear fuel and illustrating circumferential and longitudinal weld joints or seams;

FIG. 2 is a close-up detail of a weld line taken from FIG. 1;

FIG. 3 is a graph showing typical residual stress distribution in the circumferential direction in the shell of the weldment subsequent to the mechanical rolling operation and prior to welding;

FIG. 4 is a transverse cross section through the full penetration depth weld of the weldment taken from FIG. 2;

FIG. 5 is a perspective view showing a peening process used in the formation of the shell weldment of FIG. 1 which employs peening passes on the welds and respective heat affected zones (HAZs); and

FIG. 6 is a flow chart showing an exemplary process or method for forming a cylindrical shell-type weldment according to the present disclosure.

All drawings are schematic and not necessarily to scale. Numbered parts in one figure appearing un-numbered in other figures are the same parts unless expressly noted otherwise and/or given new part numbers.

### DETAILED DESCRIPTION

The features and benefits of the invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

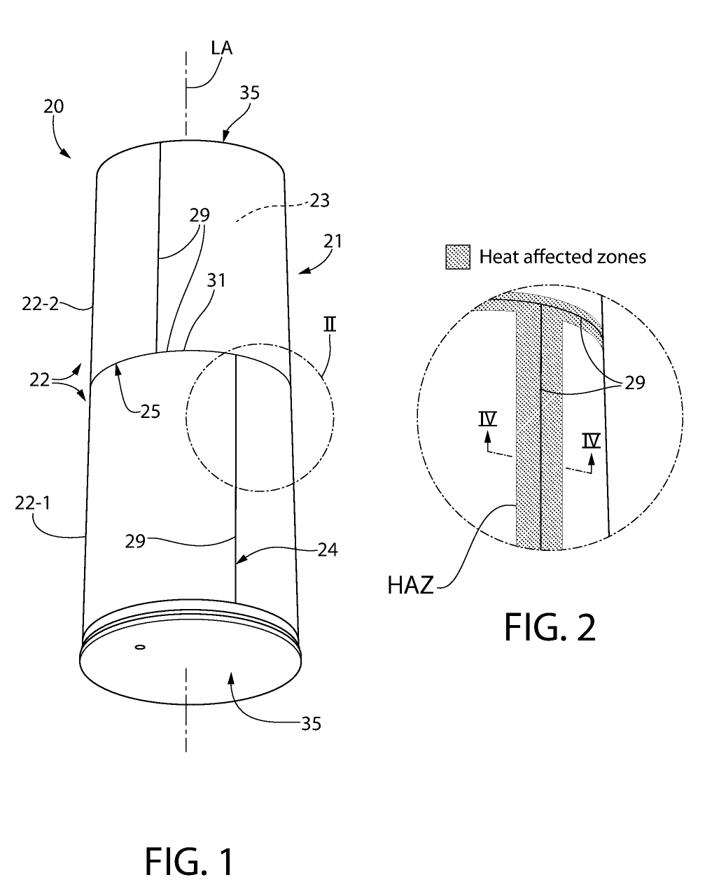

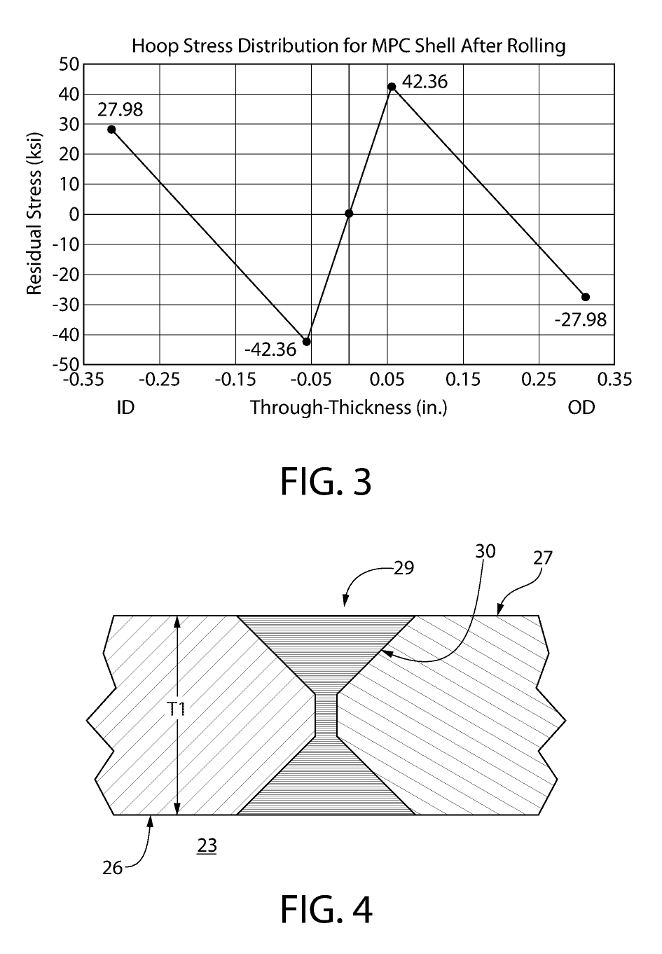

The process or method to protect the shell-type weldments from stress corrosion cracking (SCC) due to prolonged exposure to the halide bearing aqueous ambient environment according to the present disclosure is now further described. FIGS. 1-2 and 4-5 depict a cylinder shell-type welded assembly or “weldment” which may be formed using the SCC-inhibiting method disclosed herein.

Referring now to FIGS. 1-2 and 4-5, a shell weldment 20 comprises a shell 21 having a longitudinal axis LA which may be formed of one or more stacked and abutted welded shell segments 22. In the non-limiting example shown, the shell 21 may comprise a first segment 22-1 and second segment 22-2. Each segment is formed of an originally flat metal workpiece comprising a plate that has been rolled by a conventional mechanical rolling process into the cylindrical shape shown. Such mechanical rolling fabrication processes are well known in art without undue elaboration here. As a result of rolling formation, each segment 22-1, 22-2 comprises a single open longitudinal butt joint or seam 24, which is then welded to structurally join the opposing adjacent paired longitudinal edges 30 along the weld joint or seam together. This closes the seam and ultimately contributes to forming a hermetically sealed internal cavity 23 of the shell.

Shell segments 22-1 and 22-2 may be abutted in stacked end 31 to end 31 relationship to form a circumferential butt joint or seam 25, which is then welded to form a weld 29 and structurally join the two shell segments together, thereby collectively creating the entire shell weldment 20. The circumferential welded seam 25 is oriented perpendicularly to longitudinal axis LA. The circumferential welded seam 25 between the segments 22-1, 22-2 may follow a straight arcuate and circular path (versus undulating) such that the ends 31 of the shell segments share a common reference plane. The longitudinal welded seams 24 may be linear and parallel to longitudinal axis LA as shown in FIG. 1.

The circumferential and longitudinal welds 29 may each be full penetration or thickness welds having a transverse configuration or profile as shown in FIG. 4. This figure shows a transverse cross section through one of the welded longitudinal seams 24, but is representative of the same transverse profile of the welded circumferential seam 25 between the segments 22-1, 22-2. Each weld 29 extends for the full thickness T1 of the shell segment base material from an interior surface 26 to an exterior surface 27 of the shell(s).

In one embodiment, the weld may be a double-V groove weld having the double-sided V-groove and weld profile shown in FIG. 4. This figure shows conventional double-V groove weld end preparations of the shell workpiece material for forming double-V welds having a corresponding double-V joint profile. Double-V groove welds typically require less weld filler material are generally preferred when the weld joint is accessible for welding from both sides of the shell (i.e. inside and outside) in contrast to a single-V joint welds. In addition, double-V welds may have concomitantly reduced residual stresses and longitudinal shrinkage; the former of which is advantageous to minimize exposure to SCC. Other type welds and weld profiles, however, may be used in other situations and embodiments.

In one embodiment, each shell segment 22-1, 22-2 may preferably be formed of a corrosion resistant metal particularly when used to form a spent nuclear fuel storage canister. The metal preferably may be stainless steel, and more preferably an austenitic stainless steel in one non-limiting example. The shell segments may have any suitable thickness T1 depending on the structural requirements for the vessel.

It bears noting that each longitudinal or circumferential weld is actually formed by multiple “passes” or “runs” by the welder (manual or automated welding machine); each of which deposits weld metal (i.e. weld bead) into the double-V groove joint to successively build the weld to the final shape and configuration shown in FIG. 4. The root pass or run is the first run or pass on the still open joint to deposit the initial weld bead in the inner-most portion of the groove. The root pass provides a base for subsequent filler passes to radially build out the complete double-V weld. Accordingly, each weld 29 is collectively formed of a plurality of weld beads of weld filler metal, which is a well known fact and concept in the art.

The completed shell weldment 20 may further comprise an end plate 35 on each end of the shell 21 to completely enclose the internal cavity 23 once the spent nuclear fuel has been emplaced in the shell. The top end plate 35 may be a final cover plate sealed after emplacement of fuel in the shell canister. Each end plate 35 may be welded to the shell via a suitable weld, which may be a fillet type weld in one embodiment or other. These end plate welds may optionally be subjected to the same peening operations described herein for the circumferential weld seam 25 between the two shell segments 22-1, 22-2 and longitudinal weld seams 24 of each segment, as further described herein.

The most vulnerable region in the shell weldment to SCC is the weld line and the contiguous adjoining metal mass of the shell known as the “heat affected zone” or HAZ, collectively referred to herein as the “SSC susceptible strip” or “SSS”, or alternatively simply the weld zone. The fabrication method or process for forming the shell weldment 20 presented herein to increase the resistance of this ambient-exposed SSS to SCC generally comprises of a judicious use three manufacturing/fabrication operations performed in proper sequence in one embodiment; namely: (1) Workpiece Rolling; (2) Welding; (3) Hard Rolling Weldment; and (4) Peening. Each operation is further described below in sequence.

Rolling:

The manufacturing of the shell weldment 20 begins with mechanically rolling the stainless steel workpiece plate to form the cylindrical shape of the first or second shell segment 22-1, 22-2. Preferably, cold rolling may be used if possible to provide exacting dimensions of the segments versus hot rolling. Rolling, as noted above, produces a compressive surface stress at the exterior surface 27 of the shell 21, which is an antidote to SCC. When the workpiece plate stock is first rolled into the cylinder, the entire external surface of the curved shell develops a compressive stress field that protects it against SCC.

Welding:

Welding, in contrast to rolling, generally produces tensile stress in the SSS across the entire thickness of the weld mass due to weld shrinkage, with the highest values reached at the outer or exterior surfaces 27 of the shell most susceptible to SSC given the proper ambient conditions. Unfortunately, this counteracts the benefit of initially shaping the shell 21 by rolling as described above. While the tensile stress produced by welding cannot be entirely eliminated, it can be significantly mitigated by utilizing the bevel detail presented in FIG. 4 (or similar), carefully controlling the heat input, and preferably welding the outside/exterior weld 29 bevel first proximate to exterior surface 27, then followed by welding the inside weld 29 bevel proximate to interior surface 26 of the shell. Accordingly, the exterior weld bevel may be completely formed prior to forming the interior weld bevel of the double-V butt weld to decrease the tensile stress field on the exterior of the shell 21 at the weld lines. This approach is contrary to the conventional wisdom and preferred manner in the art of forming double-V welds, which is to gradually build the weld radially outward from the deepest part or root of the weld joint uniformly from each side to prevent distortion of the workpiece. The conventional approach, however, is not beneficial for preventing SCC since creation of tensile stress on the outer or exterior surface of a shell most susceptible to SCC is not minimized to the greatest extent possible.

Any suitable welding process may be used for welding the longitudinal and circumferential seams. One non-limiting example of a suitable method is the submerged arc welding (SAW) process. Other welding processes may be used however to form the double-V groove butt welds in other instances such as without limitation shielded metal arc welding (SMAW), gas tungsten arc welding (GTAW), gas metal arc welding (GMAW), or others. The welding process used is not limiting of the invention.

Additional treatment, however, is still preferably desired to render the surface stresses compressive in the SSS (“SSC susceptible strip”) after welding, as now further described below.

Hard Rolling of the Cylindrical Weldment:

One advantageous ameliorative step to mitigate SSC is to next mechanically hard roll (i.e. cold roll) the entire shell 21 again including along the SSS (i.e. weld line and adjoining HAZs) after welding the shell weldment 20. In some embodiments, at least the SSS is hard rolled if not the entire shell. Hard rolling is a process of applying high compressive surface pressure via a mechanical roller such that the nominal contact stress at the roller-to-shell interface is in the plastic range of the base shell material. This has the effect of inducing a superficial compressive stress on the rolled shell surfaces at the SSS.

Peening:

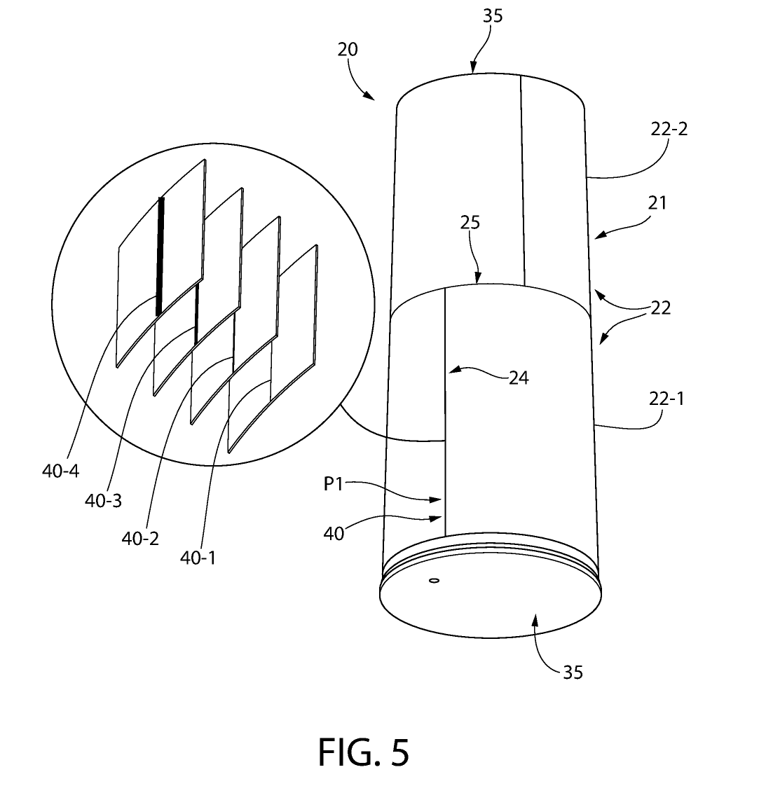

Surface peening P1 illustrated in FIG. 5 is preferably next applied after the foregoing initial rolling, welding, and second hard rolling operations have been completed. Peening is, in essence, a controlled bombardment of a metal surface with micro-impingements to develop a compressive state of stress on the surface and in its immediate vicinity. Several techniques of micro-impinging a target surface are in use in the industry, including mechanical, hydrodynamic, and laser peening methods. While the actual method of energy delivery to the target surface by each peening method varies, the underlying mechanics is the same. The concentrated localized force on the impacted or peened surface causes it to deform, thereby creating a compressive planar stress field due to the classical Poisson effect. The effectiveness of the method relies on the manner in which the Poisson stresses from successive local depressions interact with each other. The overlap between the successive impinged depressions, the magnitude of the impact energy, and the number of peening passes are critical parameters that are crucial in determining the depth and planar uniformity of the compressive stress field developed. Computer Code LS-DYNA has been invaluable in helping identify the above parameters to yield best results.

The most important requirement demanded of the peening process is that it will impart a deep layer of compressive stress in the most vulnerable region which is the welded region of the shell 21 where the weld and adjoining HAZ lies. This can be achieved by repeating the peening on the welded region in multiple passes. However, it bears noting that peening or hammering the weld strip (weld and HAZ) has the perverse effect of generating a tensile stress on the surface of the shell adjacent to the peened area (also observed in LS-DYNA simulations).

To deal with this problem, it is proposed to successively and progressively widen the peening strip or region using subsequent passes, as shown in FIG. 5, such that the outer edges of peened region 40 (where tensile stress will develop in the shell) is progressively pushed farther outwards and away from the SSS (SSC susceptible strip). Because the peening process targets the SSS associated with only the weld seams 24, 25, the peened region 40 may resemble a somewhat narrow strip or band in shape confined to the general vicinity of the longitudinal and circumferential shell welds. If the multi-pass peening is adroitly applied (guided by LS-DYNA simulations), then it is possible to move the location of tensile stress well outside the SSS, and in the case of the circumferential weld seam 25, make its magnitude small enough to be overshadowed by the compressive stress installed or imparted to the shell by the hard rolling operation performed immediately before the peening operation. In the longitudinal weld seam 24 direction, the residual compressive stress created by hard rolling is less significant; therefore, the control of the heat input during welding and use of progressively wider peening strips 40-1, 40-1, 40-3, and 40-4 as illustrated are even more critical to the prevention of SCC.

It bears noting that in FIG. 5, the first peening pass is configured and designed to create the narrowest peened region 40-1 in the SSS region. Subsequent peening passes are each selected to create progressively widen the peened regions 40-2 to 40-4, with the latter creating the widest peened region 40-4 having edges at the interface between un-peened and peened areas of the shell (where the tensile stress will develop) located sufficiently distal to the weld and HAZ to prevent the onset of SCC associated at the weld seams.

In the illustrated embodiment, four peening passes are discloses which is not limiting of the number of peening passes that be used to create the peened regions 40 along the weld lines. Other embodiments may thus use more or less peening passes.

The beneficial end result of the peening process is that the SSS most susceptible to the onset of SCC has now been converted from a tensile to a compressive stress field which resists SSC, while the portions of the shell base material proximate and adjacent to the final peened strip or region 40-4 far removed from the SSS has a relatively narrow residual tensile stress field.

Thus, in summary, multi-step rolling in conjunction with multi step peening operations as presented herein advantageously ensures that the SSS (SSC susceptible strip comprising the weld and its adjoining HAZ) and the remainder of the shell is devoid of residual tensile surface stresses.

In one non-limiting example of a shell weldment 20 which may form a spent nuclear fuel canister, the thickness T1 of the shell 21 may typically be about ½ to ⅝ inches. The weld bevels used on the interior and exterior of the double-V welds 29 may be about 37.5 degrees (nominal). The weld bevels may have a depth of about ⅛ to 3/16 inches. Other weld bevel angles, bevel dimensions, and shell thicknesses T1 may be used and is not limiting of the invention.

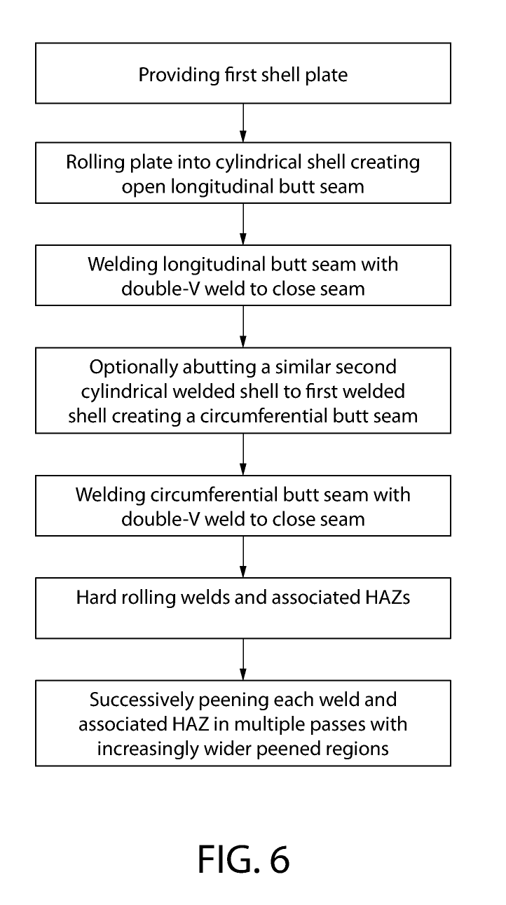

FIG. 6 is a flow chart summarizing the steps of the foregoing method or process of forming a shell weldment 20. This figure assumes, as a non-limiting example, that the weldment is formed by two longitudinally-abutted shell segments 22-1, 22-2 each comprising a longitudinal welded seam 24. Other examples may include a third or more shell segments, or optionally may only include a single shell segment depending on the length of the vessel required and size-based fabrication limitations of the particular mechanical rolling machines used for initially forming the cylindrical shell shapes from flat plate stock.

The first step is providing the first shell plate in the form of a flat plate stock of metal such as austenitic stainless steel. Next, the flat plate is rolled into a cylindrical shape which creates an open longitudinal butt seam along the abutted side or lateral edges of the plate. If not already having the desired double-V weld edge preparation, such an edge preparation is formed creating the double-V joint profile shown in FIG. 4. Next, a double-V weld is formed in the seam by preferably forming the exterior weld bevel first completely, following by forming the interior weld bevel completely. This reduces the residual tensile stresses creating by welding at the exterior surface 27 of the weld most susceptible to SCC. The first welded shell segment 22-1 is now created.

Next, a similarly formed second cylindrical welded shell segment 22-2 is axially butted end-to-end to first welded shell segment 22-1 if a second segment is required. This creates a circumferential butt seam between the two end of the shell segments 22-1, 22-2. If not already having the desired double-V weld end preparation, such an end preparation is formed creating the double-V joint profile shown in FIG. 4. Welding the circumferential butt seam with double-V weld to close seam is the next step to join the two shell segments together.

Now that all welds (longitudinal and circumferential) have been formed, the process continues with hard rolling entire shell including all longitudinal and circumferential welds and their respective HAZs. This partially converts the residual tensile stresses created by welding particularly at the exterior surface of the shell 21 into compressive stresses less susceptible to the onset of SCC. Next, each weld and associated HAZ are successively peened in multiple passes with increasingly and progressively wider peened regions 40-1, 40-2, 40-3, and 40-4. This advantageously further increases the compressive stress field on the exterior surface 27 of the shell 21 at the welds 29 and HAZs (i.e. SSS region or weld zones), in addition to moving any residual tensile stresses in the shell adjacent to the final peened region 40-4 farther away from the weld lines.

The end result of the foregoing shell weldment fabrication process is a vessel with residual substantially compressive stress fields at its exterior surface 27, particularly along the weld lines and HAZs (i.e. SSS). Such a vessel fabricated in this manner therefore lacks the needed condition of an exterior tensile stress field along the weld lines, which is one of the required conditions for SCC to initiate in the SSS.

It bears noting that the initial shell rolling, welding, hard rolling, and peening operations of the foregoing shell fabrication process are preferably performed in the sequence described above to optimize the creation of residual compressive stresses in the shell weldment 20 for SCC resistance.

While the foregoing description and drawings represent some example systems, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

What is claimed is:

1. A method for fabricating a shell weldment, the method comprising:
providing a cylindrical shell of stainless steel having an open butt seam;
welding the butt seam to close the butt seam with a weld, the welding creating a heat affected zone in the shell adjoining the weld;
rolling a weld zone collectively comprising the weld and heat affected zone under a compressive force after welding; and
peening the weld zone.

2. The method according to claim 1, wherein the weld zone is peened in multiple passes, each of the peening passes being selected to successively and progressively produce wider peened regions on the shell along the weld zone.

3. The method according to claim 2, wherein the weld is a double-V weld formed by first forming an exterior weld bevel following by forming an interior weld bevel to complete the weld.

4. The method according to claim 1, wherein the compressive force in the step of rolling the weld zone is created via a mechanical roller, the compressive force having a magnitude such that a nominal contact stress at a roller-to-shell interface is in the plastic range of the shell material.

5. The method according to claim 1, wherein the providing step includes first mechanically cold rolling a flat plate of stainless steel to create the cylinder shell, and wherein the open butt seam is a longitudinal seam created between two opposing edges of the shell.

6. The method according to claim 1, wherein the stainless steel is austenitic stainless steel.

7. The method according to claim 1, wherein the peening step uses a process selected from the group consisting of mechanical, hydrodynamic, and laser peening.

8. The method according to claim 1, wherein the shell weldment is a spent nuclear fuel canister.

9. The method according to claim 1, wherein a residual stress field in the weld zone on an exterior of the shell is compressive after the peening step.

10. The method according to claim 1, wherein the open butt seam is a circumferential seam.

11. A method for fabricating a stainless steel shell weldment, the method comprising:
rolling a flat workpiece of stainless steel to form a cylindrical shell, opposing side edges of the shell meeting at an open longitudinal butt joint;
forming a double-V weld in the longitudinal butt joint to close the joint;
rolling the weld and a heat affected zone in the shell adjoining the weld by applying a compressive force with a mechanical roller, the weld and heat affected zone collectively defining a weld zone; and
peening the weld zone at an exterior surface of the shell.

12. The method according to claim 11, wherein the double-V weld is forming by first forming an exterior weld bevel following by forming an interior weld bevel to complete the weld.

13. The method according to claim 11, wherein the shell and weld zone is peened in multiple passes, each of the peening passes being selected to successively and progressively produce wider peened strips on the shell along the weld zone and adjacent portions of the shell.

14. The method according to claim 11, wherein the compressive force creates a nominal contact stress at a roller-to-shell interface which is in the plastic range of the shell material.

15. The method according to claim 11 wherein the stainless steel is austenitic stainless steel.

16. The method according to claim 11, wherein the peening step uses a process selected from the group consisting of mechanical, hydrodynamic, and laser peening.

17. The method according to claim 11, wherein the shell weldment is a spent nuclear fuel canister.

18. The method according to claim 11, wherein a residual stress field in the weld zone on an exterior of the shell is compressive after the peening step.

19. A method for fabricating a stainless steel cylindrical shell weldment, the method comprising:
providing a first cylindrical shell segment and a second cylindrical shell segment, each shell segment being formed of austenitic stainless steel and comprising having an open longitudinal butt seam;
closing the butt seams of each of the first and second shell segments by forming a double-V longitudinal weld in the longitudinal butt seams, the formation of the longitudinal welds creating a respective heat affected zone in the shell segments adjoining each longitudinal weld;
placing the first and second shell segments in abutting end-to-end relationship forming a circumferential butt seam therebetween;
closing the circumferential butt seam by forming a double-V circumferential weld in the circumferential butt seam, the formation of the circumferential weld creating a respective heat affected zone in the shell segment adjoining the circumferential weld;
applying an inward directed compressive force against the longitudinal and circumferential welds and their heat affected zones by a mechanical roller; and
peening the shell segments along the longitudinal and circumferential welds and their respective heat affected zones in multiple peening passes, each of the peening passes being selected to successively and progressively produce wider peened strips on the shell in vicinity of the welds and their respective heat affected zones;
wherein a residual stress field proximate to the longitudinal and circumferential welds on an exterior of the shell segments is compressive after the peening step.

20. The method according to claim 19, wherein the compressive force creates a nominal contact stress at a roller-to-shell interface which is in the plastic range of the shell material.
